(19) United States
(12) Patent Application Publication
(10) Pub. No.: US 2007/0253384 A1
(43) Pub. Date: Nov. 1, 2007

(54) Wireless switch with bootable flash memory storage device

(75) Inventors: Sameer Kanagala, San Carlos, CA (US); Edward Geiger, San Martin, CA (US)

Correspondence Address: INGRASSIA FISHER & LORENZ, P.C., 7150 E. CAMELBACK, STE. 325, SCOTTSDALE, AZ, 85251, US

(73) Assignee: Symbol Technologies, Inc.

(21) Appl. No.: 11/529,951

(22) Filed: Sep. 29, 2006

Related U.S. Application Data
(60) Provisional application No. 60/797,018, filed on May 1, 2006.

(51) Int. Cl. H04Q 7/24

(52) U.S. Cl. 370/338

(57) ABSTRACT

A wireless switch for a wireless local area network (WLAN) as disclosed herein includes an integrated nonvolatile memory card interface that enables communication with compliant portable nonvolatile memory cards such as CompactFlash memory cards. A portable memory card can be utilized by the wireless switch and/or by other network components that are coupled to the wireless switch via the WLAN. In one practical embodiment, the portable memory card is configured to store boot code for the wireless switch, client device data, supplemental (update) code for the wireless switch, and/or log data for the wireless switch.

### CROSS-REFERENCE TO RELATED APPLICATION(S)

This application claims the benefit of U.S. provisional patent application Ser. No. 60/797,018, filed May 1, 2006.

### TECHNICAL FIELD

Embodiments of the present invention relate generally to a wireless switch suitable for use in a wireless local area network (WLAN). More particularly, embodiments of the present invention relate to a wireless switch having an integrated interface for a portable flash memory card.

### BACKGROUND

There has been a dramatic increase in demand for mobile connectivity solutions utilizing various wireless components and WLANs. This generally involves the use of wireless access points that communicate with mobile devices using one or more RF channels. A WLAN may operate in accordance with one or more of the IEEE 802.11 standards.

WLANs can give clients the ability to “roam” or physically move from place to place without being connected by wires. In the context of a WLAN, the term “roaming” describes the act of physically moving between wireless access devices, which may be stand-alone wireless access points or wireless access ports that cooperate with one or more wireless switches located in the WLAN. Many deployments of wireless computer infrastructure, such as WLANs, involve the use of multiple wireless switches serving a number of wireless access devices. Conventional wireless switches generally function as network interfaces between wireless access devices and a traditional computer network, such as a local area network (LAN).

Depending upon its intended application, a wireless switch might require a small amount of memory or a significant amount of memory to support its operation. For example, such memory may be desirable to store diagnostic data, to facilitate event logging, to enable performance tracking, and/or to store any other recordable data or information at the wireless switch. A conventional wireless switch, however, typically includes a fixed amount of storage capacity, and expansion of that storage capacity can be an expensive and time consuming modification.

Wireless switching systems are used in connection with access ports and/or access points that communicate wirelessly with associated mobile units. Older wireless switching systems are unsatisfactory in a number of respects, and it is thus desirable to provide improved systems for controlling wireless devices.

### BRIEF SUMMARY

A wireless switch configured as described herein can be deployed to support a WLAN. The wireless switch includes an integrated memory card interface that enables compatible nonvolatile memory storage devices to communicate with the wireless switch, the WLAN, and/or with other components on the computer network via the wireless switch. A compatible nonvolatile memory storage device can be utilized to provide data storage capacity for client device data, to provide software updates for the wireless switch, and/or to provide boot code for the wireless switch.

The above and other features may be carried out in one embodiment by a wireless switch subsystem for a WLAN. The wireless switch subsystem includes a wireless switch comprising an integrated memory card interface and a nonvolatile memory card that is compliant with the memory card interface. The nonvolatile memory card includes boot code for the wireless switch stored therein.

The above and other features may be carried out in another embodiment by a method of operating a wireless switch for a WLAN, the wireless switch having an integrated memory card interface. The method involves: coupling a nonvolatile memory card to the memory card interface, the nonvolatile memory card including boot code for the wireless switch stored therein; entering a recovery mode for the wireless switch; and booting the wireless switch from the nonvolatile memory card in response to entering the recovery mode.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is a schematic representation of a computer network configured in accordance with one embodiment of the invention;

FIG. 2 is a schematic representation of a wireless switch connected to a flash memory device;

FIG. 3 is a perspective view of a wireless switch configured in accordance with an embodiment of the invention;

FIG. 4 is a schematic representation of a wireless switch configured in accordance with an embodiment of the invention; and

FIG. 5 is a flow chart that illustrates a boot process that may be supported by a wireless switch.

### DETAILED DESCRIPTION

The following detailed description is merely illustrative in nature and is not intended to limit the embodiments of the invention or the application and uses of such embodiments. Furthermore, there is no intention to be bound by any expressed or implied theory presented in the preceding technical field, background, brief summary or the following detailed description.

Embodiments of the invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the invention may be practiced in conjunction with any number of data transmission protocols and network configurations, and that the system described herein is merely one example embodiment of the invention.

For the sake of brevity, conventional techniques related to WLANs, data transmission, signaling, network control, wireless access device operation, wireless switch operation, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in a practical embodiment.

The following description refers to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically.

As used herein, “universal serial bus” and “USB” refers to the standardized serial data communication bus technology of the same name, and these terms contemplate the older USB 1.1 Specification, the newer USB 2.0 Specification, and any future variant or modification thereof. These USB Specifications are incorporated by reference herein. The USB 2.0 Specification and other USB-related technical publications are available at the website www.usb.org.

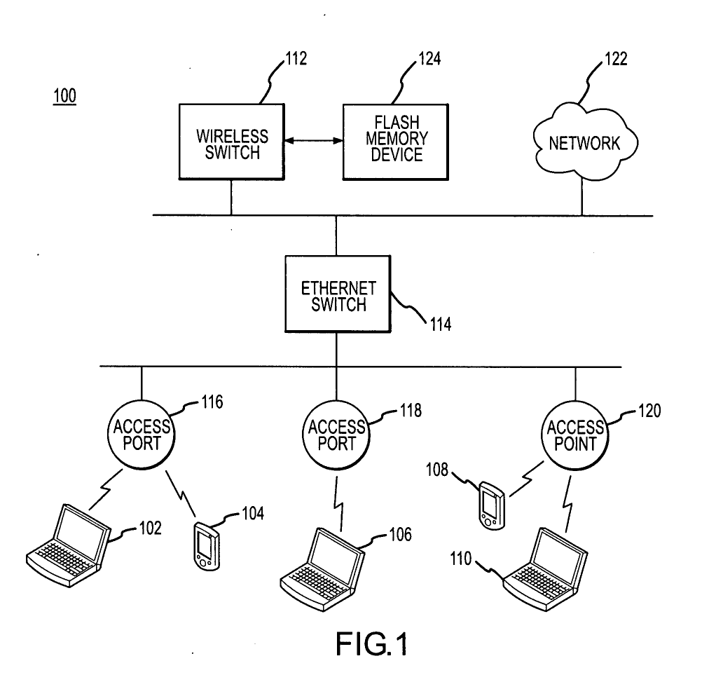

FIG. 1 is a schematic representation of a computer network 100 configured in accordance with an example embodiment of the invention. In this example, computer network 100 includes a WLAN. Computer network 100 generally includes wireless clients (identified by reference numbers 102, 104, 106, 108, and 110), a wireless switch 112, an Ethernet switch 114, and a number of wireless access devices (identified by reference numbers 116, 118, and 120). Computer network 100 may also include or communicate with any number of additional network components, such as a traditional local area network (LAN). In FIG. 1, such additional network components are generally identified by reference number 122. A practical embodiment can have any number of wireless switches, each supporting any number of wireless access devices, and each wireless access device supporting any number of wireless clients. Indeed, the topology and configuration of computer network 100 can vary to suit the needs of the particular application and FIG. 1 is not intended to limit the application or scope of the invention in any way.

In this example, wireless access devices 116/118 are realized as wireless access ports, which are “thin” devices that rely on the network intelligence and management functions provided by wireless switch 112, while wireless access device 120 is realized as a wireless access point, which is a “thick” device having the network intelligence and processing power integrated therein. Thus, wireless access point 120 need not rely upon wireless switch 112 for operation. Wireless access ports having conventional features that can be incorporated into wireless access devices 116/118, and wireless access points having conventional features that can be incorporated into wireless access device 120 are available from Symbol Technologies, Inc. Briefly, a wireless access device as described herein is suitably configured to receive data from wireless clients over wireless links. Once that data is captured by the wireless access device, the data can be processed for communication within computer network 100. For example, the data can be encapsulated into a packet format compliant with a suitable data communication protocol. In the example embodiment, data is routed within computer network 100 using conventional Ethernet 802.3 addressing (including standard Ethernet destination and source packet addresses).

Wireless switch 112 is coupled to Ethernet switch 114, which is in turn coupled to wireless access devices 116/118/120. In practice, wireless switch 112 communicates with wireless access devices 116/118 via Ethernet switch 114. A given wireless switch can support any number of wireless access devices, i.e., one or more wireless access devices can be concurrently adopted by a single wireless switch. In the example embodiment, a wireless access device can be adopted by only one wireless switch at a time; this is part of the 802.11 standard wherein a wireless access device (station) can only be associated with a single access point while an access point can adopt multiple stations. The wireless clients are wireless devices that can physically move around computer network 100 and communicate with network components 122 via wireless access devices 116/118/120.

As described herein, a wireless switch is suitably configured to communicate with portable memory devices using one or more standardized form factors. For example, wireless switch 112 may be suitably configured to communicate with a flash memory device 124 that can be inserted into an appropriate port, slot, or interface in the wireless switch. In the preferred embodiment described herein, wireless switch 112 includes an externally accessible port for a nonvolatile memory card (e.g., a CompactFlash memory card) and the processing logic necessary to read and write data to compatible nonvolatile memory cards.

Briefly, computer network 100 allows portable nonvolatile memory devices to be attached to a WLAN via wireless switch 112. Such portable nonvolatile memory devices may be compliant with any suitable format, including, without limitation: CompactFlash; Secure Digital (SD); Memory Stick; MultiMediaCard (MMC); or SmartMedia (SM). Portable nonvolatile memory devices can be useful for remote data storage and event logging associated with wireless switch 112, and for other applications described herein. Once coupled to computer network 100, a portable nonvolatile memory device can be accessed by other network devices (which may reside on the WLAN or the LAN).

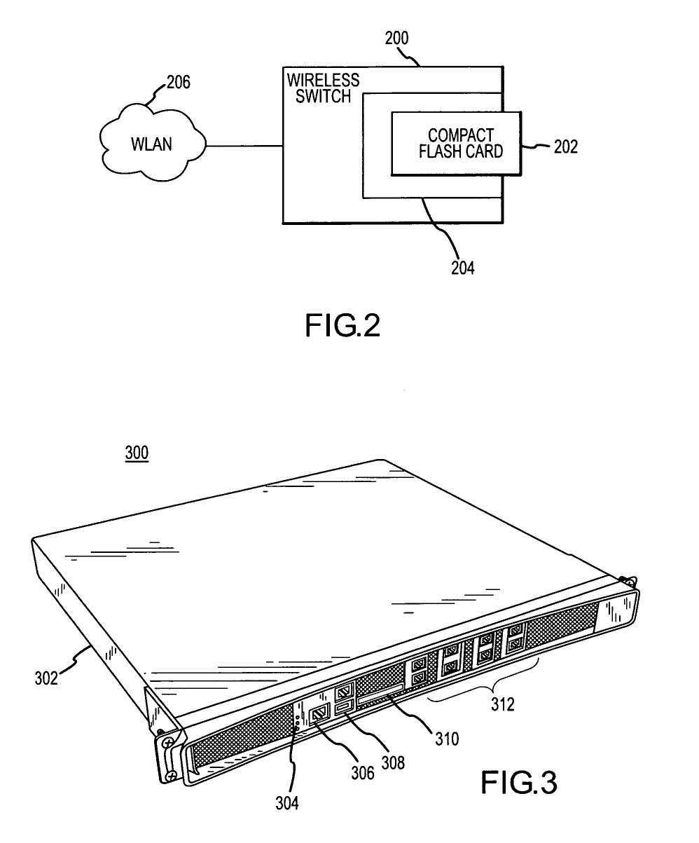

FIG. 2 is a schematic representation of a wireless switch 200 connected to a CompactFlash memory card 202 via a CompactFlash memory card interface 204. As used herein, a “memory card interface” refers to the operating hardware, software, firmware, processing logic, and protocols, individually or in any combination thereof, that supports data communication with the particular portable nonvolatile memory device utilized by the wireless switch (a CompactFlash compatible card is described herein as one preferred and non-limiting embodiment). Accordingly, memory card interface 204 may include physical and electrical elements, components, and/or features associated with the particular nonvolatile memory device. For example, memory card interface 204 may include a CompactFlash port or receptacle (a hardware element that provides physical and electrical connectivity) integrated into the housing of wireless switch 200.

Wireless switch 200 may be considered to be a component of a WLAN 206. When coupled to wireless switch 200, CompactFlash memory card 202 may also be considered to be a component of WLAN 206. The combination of wireless switch 200 and CompactFlash memory card 202 may be referred to herein as a wireless switch subsystem for WLAN 206.

FIG. 2 depicts one example arrangement where CompactFlash memory card 202 is a distinct component that is externally coupled to wireless switch 200 using an externally accessible memory card interface 204, which is integrated into wireless switch 200. In other words, at least a portion of memory card interface 204 is externally accessible. In alternate embodiments, however, memory card interface 204 may be contained within the housing or package for wireless switch 200 and CompactFlash memory card 202 may be realized as an internal subcomponent or an internally mounted device for wireless switch 200. Such internal installations may be desirable to support feature enhancements, provide product upgrades, or to implement customized product specifications. For example, wireless switch 200 may include interior space that can accommodate one or more CompactFlash memory cards (or other memory storage devices). Such memory storage devices can provide additional capacity for event logging, error logging, trouble shooting data, firmware uploading, or the like.

FIG. 3 is a perspective view of a wireless switch 300 configured in accordance with an embodiment of the invention. Wireless switch 300 includes various advantageous features. For example, wireless switch 300 may utilize a field programmable gate array (FPGA) to perform certain logic functions within the switch. In addition, a computer-based processor may be included within wireless switch 300—i.e., an application processor serving as an adjunct to the processor running the switch software. This allows, for example, a server to be incorporated into wireless switch 300. The processor might also be a voice processor and a DSP interface, thereby creating a PBX within the switch.

Wireless switch 300 may also be suitably configured to accept a CompactFlash card or other portable nonvolatile memory device. The nonvolatile memory storage device includes code, data, etc. that assists with reloading wireless switch 300 after initial switch activation. Moreover, a USB port can be included on the exterior of wireless switch 300 for interfacing with one or more USB devices. For example, a memory stick or other USB drive may be used to transfer information and/or code from or to wireless switch 300.

Another feature of wireless switch 300 relates to the use of a switch incorporating a boot halt. That is, the user is allowed to halt the boot process in order to enter a diagnostic mode, thereby allowing advanced troubleshooting. In accordance with another feature of wireless switch 300, booting is initiated via a NAND device rather than a NOR device as used in existing wireless switch devices.

In one embodiment, wireless switch 300 incorporates an integrated uninterruptible power source (UPS). The UPS provides a backup in the event of a power failure. It can provide power for a specified period or just enough power for proper power-down of wireless switch 300.

In another embodiment, a locator light is incorporated into wireless switch 300. That is, a switch or other feature is provided on one side of wireless switch 300 (e.g., the face), wherein activation of the switch results in a light (LED, etc.) being activated on another surface (e.g., the back) of wireless switch 300.

Another feature allows weather testing via wireless switch 300. In this embodiment, one or more environment-related sensors are incorporated into or on the wireless switch 300. Such sensors might sense, for example, relative humidity, pressure, temperature, wind speed, or the like.

A practical embodiment of wireless switch 300 will include components and elements configured to support known or conventional operating features that need not be described in detail herein. In the example embodiment, wireless switch 300 communicates with wireless access devices and wireless switch 300 provides the switching intelligence and processing logic to ensure that data for a given communication session is directed to and from the correct wireless access device. As mentioned above, an access device connects users to other users within the network and can also serve as the point of interconnection between a WLAN and a fixed wire network. Each access device can serve multiple users within a defined network area. As a wireless client moves beyond the range of one access device, the wireless client can be automatically handed over to another access device, e.g., a different access point or a wireless access port supported by a wireless switch. In practice, the number of wireless access devices in a given network generally increases with the number of network users and the physical size of the network.

Wireless switch 300 includes a physical housing 302 that surrounds and protects the components of wireless switch 300. A number of features, elements, and components of wireless switch 300 may be accessible from the exterior of housing 302. In this example, most of these accessible and/or viewable features are located at the front face panel of wireless switch 300. In this regard, wireless switch 300 may include, without limitation: one or more system LED lights 304; an out-of-band management port 306; one or more USB ports 308; one or more memory card slots 310; and various Ethernet connectors, jacks, or ports 312.

LED lights 304 are configured to provide a visual indication of the operating condition of wireless switch 300. LED lights 304 may, for example, indicate system status, fan status, thermal status, or the like. Out-of-band management port 306 provides an alternate and direct route to the management port of each device that can be used for reconfiguration, troubleshooting, and rebooting. This route is not dependent upon telnet or SNMP packets moving through the LAN/WAN system, and it provides connectivity even when the network is down. In other words, out-of-band management port provides a management interface which allows other networking devices such as routers, laptops computers, remote management entities, other switches, etc. to determine the status of wireless switch 300 and to also control management variables such as configurations, security, load, networking tables, etc. USB port 308 is configured for compatibility with USB devices and USB cables. Wireless switch 300 may include any number of USB ports 308 that are accessible from outside the housing 302.

Memory card slot 310 is suitably configured to receive a compatible nonvolatile memory storage card. In this regard, memory card slots 310 may be designed to accommodate any number of memory card form factors including, without limitation: CompactFlash; Secure Digital (SD); Memory Stick; MultiMediaCard (MMC); ExpressCard; PCMCIA; or SmartMedia (SM). In preferred embodiments, memory card slots 310 are configured to accommodate hot-swappable nonvolatile memory storage devices, such as CompactFlash memory devices. Ethernet connectors 312 facilitate connection of wireless switch 300 to various WLAN or LAN components. In this regard, Ethernet connectors 312 may be realized as standard RJ-45 connectors, standard Small Form-Factor Pluggable (SFP) connectors, or the like.

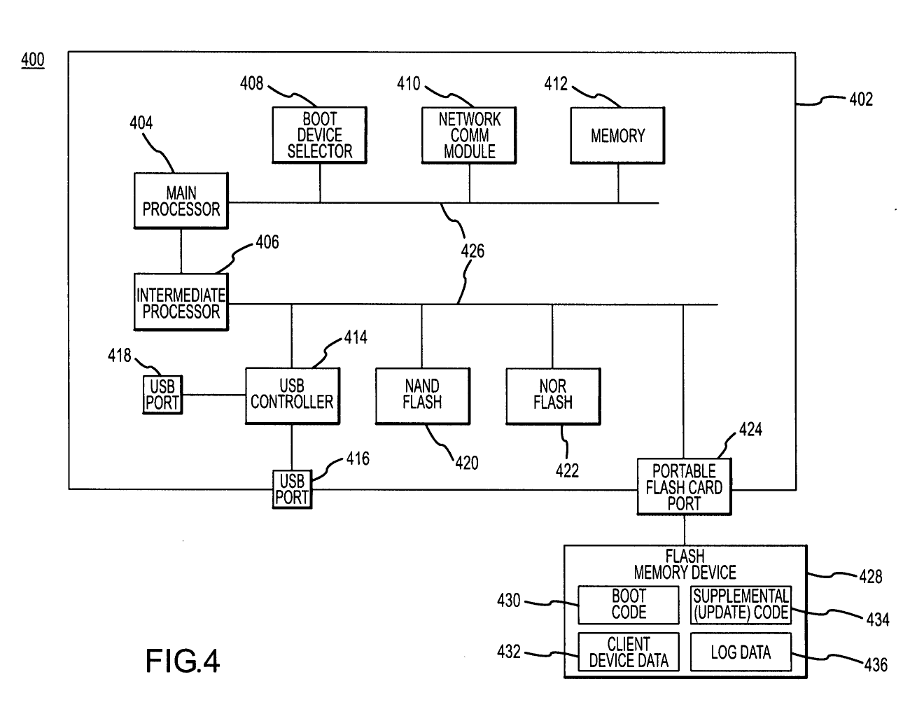

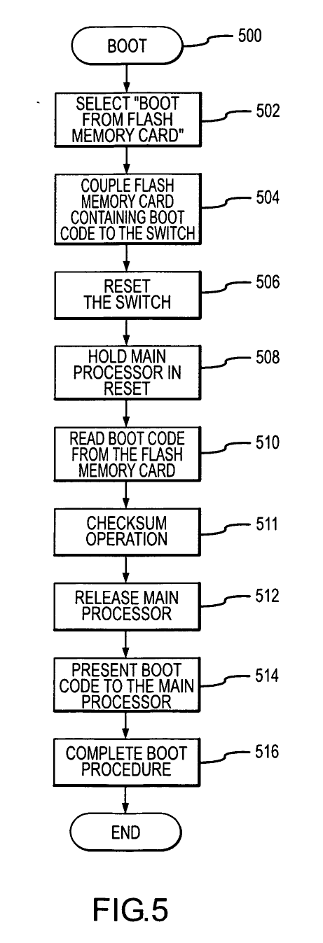

FIG. 4 is a schematic representation of a wireless switch 400 configured in accordance with an embodiment of the invention. Wireless switch 400 may be realized using the packaging shown in FIG. 3. A practical embodiment of wireless switch 400 will include components and elements configured to support known or conventional operating features that need not be described in detail herein (accordingly, FIG. 4 is a simplified illustration that omits elements that might otherwise be found inside the housing 302 of wireless switch 300).

Wireless switch 400 generally includes a housing 402, a main processing element (main processor) 404, an intermediate processing element (intermediate processor) 406, a boot device selector 408, a network communication module 410, a suitable amount of memory 412, a USB interface that includes a USB controller 414 and at least one USB port 416/418, a suitable amount of NAND flash memory 420, a suitable amount of NOR flash memory 422, and a portable flash memory card port 424. These and other elements of wireless switch 400 may be interconnected together using a bus 426 or any suitable interconnection arrangement. Such interconnection facilitates communication between the various elements of wireless switch 400. In this example embodiment, all of the illustrated components other than USB port 416, portable flash memory card port 424, and flash memory device 428 are located within housing 402, which represents the physical package for wireless switch 400.

Main processing element 404 may be implemented or realized with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this regard, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Main processing element 404 is primarily responsible for the general operation of wireless switch 400, e.g., switching, data communication, and wireless packet processing. In contrast, intermediate processing element 406 is primarily responsible for handling inputs and outputs for wireless switch 400 and for managing peripherals for wireless switch 400 (intermediate processing element 406 is suitably configured to perform the various functions described in more detail below). This intermediate processing element 406 also supplies the processor with the actual boot image once it has retrieved it from the device specified by boot device selector 408 as well as control elements of the boot process prior to the startup of the main processing element. Thus, main processing element 404 and intermediate processing element 406 represent the processing logic that carries out the functions, techniques, and processing tasks associated with the operation of wireless switch 400.

Intermediate processing element 406 may be implemented or realized in the manner described above for main processing element 404. In preferred embodiments, intermediate processing element 406 is realized as a field programmable gate array. FIG. 4 depicts intermediate processing element 406 coupled between main processing element 404 and USB controller 414, NAND flash memory 420, NOR flash memory 422, and portable flash memory card port 424 because intermediate processing element 406 functions as an interface, a data translator, and/or a data pass-through element for wireless switch 400. The intermediate processing element 406 also monitors thermal sensors and fan speeds and takes corrective action when thermal sensors detect thermal threshold crossing or fans speeds drop below RPS thresholds. These actions include but are not limited to: lowering processor speed to reduce power consumption, raising fan speeds to increase airflow, and holding the processor in reset.

Boot device selector 408 represents a selection feature on wireless switch 400 that can be manipulated to control the manner in which wireless switch 400 boots up in response to a reset command and/or a power-up condition. For example, boot device selector 408 may be a switch, a button, one or more coding pins, or any mechanism that causes wireless switch 400 to boot from a designated source, device, or component. In one embodiment, boot device selector 408 is realized as a button that causes wireless switch 400 to boot from a flash memory device 428 that is coupled to memory card port 424 (as depicted in FIG. 4). Alternatively, boot device selector 408 may be a switch that can be set to cause wireless switch 400 to boot in a normal mode (i.e., boot from NAND flash memory 420 and/or NOR flash memory 422), or boot from a USB memory device. Thus, boot device selector 408 can be manipulated in the field to recover wireless switch 400 if the normal boot operation is ineffective. Boot device selector 408 preferably remains in the same state unless changed or manipulated again. This allows wireless switch 400 to continue to boot from the selected device as needed.

Network communication module 410 generally represents the hardware, software, firmware, processing logic, and/or other components of wireless switch 400 that enable bi-directional communication between wireless switch 400 and network components to which wireless switch 400 is connected. For example, network communication module 410 may be configured to support 10/100/1000 Mbps Ethernet LAN traffic. Referring to FIG. 1 as an example, network communication module 410 is suitably configured to transmit data to components on computer network 100 (such as Ethernet switch 114, access devices, and/or additional network components 122), and to receive data from components on computer network 100. In a typical deployment, network communication module 410 provides an Ethernet interface such that wireless switch 400 can communicate with a conventional Ethernet-based computer network. In this regard, network communication module 410 may include a physical interface, such as 10/100/1000 Mbps, for connection to the computer network, and network communication module 410 (and/or main processing element 404) may handle Ethernet addressing for data packets sent from wireless switch 400.

Memory 412 may be implemented or realized with RAM memory, flash memory, ROM memory, EPROM memory, EEPROM memory, registers, a hard disk, a removable disk, a CD-ROM, or any other form of storage medium known in the art. In addition, memory 412 includes sufficient data storage capacity to support the operation of wireless switch 400. Memory 412 can be coupled to main processing element 404 such that main processing element 404 can read information from, and write information to, memory 412. In the alternative, memory 412 may be integral to main processing element 404. As an example, main processing element 404 and memory 412 may reside in a suitably configured ASIC.

The USB interface (which comprises USB controller 414, USB port 416, and/or USB port 418) is suitably configured to facilitate data communication with USB compliant devices. The USB interface may be coupled to a PCI bus in wireless switch 400, which can enable software downloads and potential firmware upgrades for the motherboard flash in wireless switch 400. Alternatively (or additionally), the USB interface may be coupled to an external memory bus in wireless switch 400. In one practical embodiment, the USB interface is located within housing 402 and is not externally accessible. USB port 418 depicts an internally located port that can be utilized for such an embodiment. In another practical embodiment, the USB interface is accessible from outside housing 402. USB port 416 depicts an externally accessible port that can be utilized for such an embodiment.

USB controller 414 generally represents the hardware, software, firmware, processing logic, and/or other components of the USB interface that control data communication (which may be bi-directional) between wireless switch 400 and USB compliant devices that might be connected to USB ports 416/418. Thus, USB controller 414 also functions to control and/or manage data communication between main processing element 404 and USB compliant devices that might be connected to USB ports 416/418. In other words, the data exchanged with the USB compliant devices can be utilized by wireless switch 400 and/or by network components coupled to wireless switch 400 via network communication module 410, under the control of main processing element 404.

As mentioned above, USB ports 416/418 are suitably configured to establish data communication with USB compliant devices. In practice, USB ports 416/418 have physical and electrical characteristics and features that are in compliance with the particular USB standard. In a practical deployment, USB ports 416/418 may be coupled to peripheral devices using USB cables. In alternate embodiments, the peripheral devices might be directly connected to USB ports 416/418.

In one embodiment, NAND flash memory 420 is realized as one or more 8-bit devices. NAND flash memory 420 may be employed as both a program storage device and a boot device (for normal operating conditions). In one embodiment, NOR flash memory 422 is realized as one or more 16-bit devices. NOR flash memory 422 may be configured as a compatible boot device that can operate directly with main processing element 404 (i.e., without interacting with intermediate processing element 406.

Portable flash memory card port 424 is an interface that allows compatible flash memory cards to communicate with the main processing element 404. Referring to FIG. 2, memory card interface 204 may include memory card port 424. Memory card port 424 can be used as a standard memory interface for storing or retrieving data or as a proprietary interface for booting wireless switch 400 and/or for loading programming files. In one embodiment, portable flash memory card port 424 supports both byte and 16-bit word transactions. In the preferred embodiment, port 424 is configured for compatibility with the CompactFlash form factor.

FIG. 4 depicts a wireless switch subsystem that includes wireless switch 400 and a portable nonvolatile flash memory storage device 428 coupled to wireless switch 400 via memory card port 424. In this example, flash memory device 428 is a hot-swappable type of nonvolatile flash memory. Although not a requirement of an embodiment of the invention, FIG. 4 depicts the following items stored in flash memory device 428: boot code 430 for wireless switch 400; client device data 432; supplemental (update) code 434 for wireless switch 400; and log data 436 for wireless switch 400. Depending upon the implementation, application, and/or deployment of the wireless switch subsystem, flash memory device 428 may include any number of these items, and possibly other data, information, code, etc.

Wireless switch 400 may include processing logic that is configured to: manage the storage and/or retrieval of client device data 432; manage the storage and/or retrieval of log data 436 for wireless switch 400; access supplemental code 434; update operating code of wireless switch 400 in accordance with supplemental code 434; access boot code 430; and/or initiate a boot procedure for wireless switch 400 in response to boot code 430. In the example shown in FIG. 4, main processing element 404 includes most of the operational processing logic, while intermediate processing element 406 is suitably configured to handle data communication between main processing element 404 and the USB interface of wireless switch 400.

Client device data 432 represents data generated by, associated with, or otherwise related to the wireless client devices that communicate with wireless switch 400 (via respective wireless access devices). In practice, a client device may have limited data storage capacity and, therefore, it may be desirable to provide additional storage for client devices at wireless switch 400. In such an embodiment, flash memory device 428 may be a card having a large data storage capacity that accommodates multiple client devices. Alternate embodiments may employ a miniature hard drive that is compatible with the particular form factor of memory card port 424. Main processing element 404 may be configured to manage storage of client device data 432 in flash memory device 428 (and retrieval of client device data 432 from flash memory device 428) via intermediate processing element 406. In connection with these type of functions, intermediate processing element 406 generally serves as a pass through device. Intermediate processing element 406 will be involved with the flash memory device interface when the particular flash memory device is the boot device. At this time intermediate processing element 406 will hold main processing element 404 in reset, initialize flash memory device 428, point it to a predetermined sector, retrieve the boot image from flash memory device 428, check the data to determine if it is really a boot image, and then release main processing element 404 from reset, allowing this element to execute the boot code stored locally by intermediate processing element 406.

Main processing element 404 can handle authentication of the wireless client devices and maintain client device data 432 in the proper context. As long as a wireless client device is authenticated, wireless switch 400 can manage data storage for that wireless client device at flash memory device 428.

Log data 436 represents data generated by, associated with, or otherwise related to wireless switch 400 itself. For example, log data 436 may indicate the amount of data traffic handled by wireless switch for each wireless access device and/or for each wireless client device. Log data 436 may also represent or include, without limitation: temperature logs, fan speed logs, interface error logs, and/or transient data for intrusion detection and protection. Storage of log data 436 in a portable flash memory device 428 may be desirable to enable a service technician to download and physically transport log data 436 in a convenient manner. Main processing element 404 may be configured to manage the storage of log data 436 in flash memory device 428 (and manage the retrieval of log data 436 from flash memory device 428) via intermediate processing element 406. In connection with such operations, intermediate processing element 406 serves as a pass through element.

Supplemental (update) code 434 may represent software updates, upgrades, patches, or fixes for wireless switch 400, wireless access devices in the WLAN, or wireless client devices in the WLAN. Supplemental code 434 may be delivered to wireless switch 400 as needed via a portable flash memory device 428. For example, the user, owner, administrator, or technician for wireless switch 400 can download supplemental code 434 from an appropriate website to flash memory device 428, then transport the loaded flash memory device 428 to wireless switch 400 so that supplemental code 434 can be transferred to wireless switch 400. Thereafter, supplemental code 434 can be installed in wireless switch 400 itself and/or transferred to a wireless access device or a wireless client device for installation. Main processing element 404 may be configured to manage the reading of supplemental code 434 from flash memory device 428 via intermediate processing element 406. In connection with such operations, intermediate processing element 406 serves as a pass through element. Main processing element 404 may also be responsible for the updating of the operating code of wireless switch 400 in accordance with supplement code 434.

Boot code 430 represents computer-executable instructions utilized to initialize wireless switch 400 after reset or upon power-up. Under normal operating conditions, wireless switch 400 will boot up from its internal NOR flash memory 422 and/or from its internal NAND flash memory 420. In preferred embodiments, the target internal boot device is NAND flash memory 420 because of speed and density. If these flash memory components fail, if wireless switch 400 is unable to boot on its own, of if wireless switch 400 is configured to do so, then boot code 430 (with boot device selector) enables wireless switch 400 to boot up in an alternate mode. Such recovery allows wireless switch 400 to operate in an extended manner without having to decommission it for repair. In certain embodiments, main processing element 404 may be unable to directly read boot code 430 from flash memory device 428. Consequently, intermediate processing element 406 can function as an interface between flash memory storage device 428 and main processing element 404. In this regard, intermediate processing element 406 is suitably configured to access and read boot code 430 stored in flash memory storage device 428, and to present boot code 430 in a format that is readable by main processing element 404. This allows main processing element 404 to initiate a boot procedure for wireless switch 400 in response to boot code 430 (with boot device selector).

In one embodiment, boot code 430 includes the first four 512-byte sectors of code needed to support a “mini-boot” of main processing element 404. Thus, boot code 430 is similar to the primary boot code that is stored in the first sector (or sectors) of NAND flash memory 420 and/or NOR flash memory 422, except that boot code 430 is formatted for the file system of flash memory storage device 428 rather than the NAND/NOR file system. In practice, there are slight differences between the boot code in NOR flash memory 422, NAND flash memory 420, and flash memory storage device 428. For example, it may not be possible to simply copy the boot code from NAND flash memory 420 to a CompactFlash card and successfully perform a boot operation (because NAND, CompactFlash, and USB devices use different memory sector lengths and are memory mapped differently within the processor address space.

Boot code 430 may represent recovery code that can be utilized to update or re-program the internal NOR flash memory and/or the internal NAND flash memory of the wireless switch. In other words, boot code 430 may be employed to boot up the wireless switch and to reprogram the boot sectors of the existing flash memory components. In such an embodiment, boot code 430 need not be utilized subsequently if the existing flash memory components can be reprogrammed in this manner.

FIG. 5 is a flow chart that illustrates a boot process 500 that may be supported by a wireless switch. The various tasks performed in connection with process 500 may be performed by software, hardware, firmware, or any combination thereof. For illustrative purposes, the following description of process 500 may refer to elements mentioned above in connection with FIGS. 1-4. In embodiments of the invention, portions of process 500 may be performed by different elements of the described system, e.g., the main processing element or the intermediate processing element of the wireless switch. It should be appreciated that process 500 may include any number of additional or alternative tasks, the tasks shown in FIG. 5 need not be performed in the illustrated order, and process 500 may be incorporated into a more comprehensive procedure or process having additional functionality not described in detail herein.

In one implementation, the main processing element boots from either its internal flash device(s) or from the boot code present in the intermediate processing element. If the internal flash is corrupt or if the intermediate processing element determines that the flash memory storage device does not contain a valid boot image, the main processing element does not function. To repair a device that should have a boot image but doesn't, the main processing element must first boot from a device with a valid image and then it can repair the corrupted or invalid image providing it has access to a good file located on another device or over a network.

Boot process 500 can be performed when the wireless switch is unable to boot up by itself via its normal boot routine. This may occur if the NOR flash memory and/or the NAND flash memory fails or is inaccessible. In such situations, process 500 provides an alternative boot mechanism for the wireless switch. In this example, process 500 may begin by instructing the wireless switch to boot from a suitable configured and programmed nonvolatile memory card rather than from the normal or primary boot code stored in the internal flash memory of the wireless switch. This causes the wireless switch to enter a different boot mode. This alternate mode may be responsive to the manipulation of a selection feature (e.g., a switch or a button) on the wireless switch (task 502). Before or after task 502, an appropriate nonvolatile memory card is coupled to a memory card interface of the wireless switch (task 504). The nonvolatile memory card contains boot code for the wireless switch stored therein, as described above in the context of FIG. 4. Task 504 may be performed in the field on an as-needed basis, or it may be performed during manufacturing such that the wireless switch will have a backup boot mechanism that does not rely on its internal flash memory devices.

Thereafter, boot process 500 reacts to the resetting, initialization, or power-up of the wireless switch (task 506) in an appropriate manner. As mentioned above, the wireless switch will normally search for the boot code in its internal flash memory components. In the alternate mode, the wireless switch is controlled such that it bypasses the internal flash memory components. This may be accomplished by holding the main processing element of the wireless switch in reset (task 508), reading the boot code from the nonvolatile memory card (task 510), performing a checksum or an equivalent error checking operation to verify that the retrieved data represents valid boot code (task 511), releasing the main processing element from reset (task 512), and presenting the boot code, which was read from the nonvolatile memory card, to the main processing element (task 514). In one example embodiment, the intermediate processing element of the wireless switch functions as an interface between the nonvolatile memory card and the main processing element (see FIG. 4). Thus, process 500 can boot the wireless switch from the nonvolatile memory card in the following manner: the intermediate processing element receives suitably formatted boot instructions from the main processing element; the normal boot memory elements (e.g., the NOR flash memory and/or the NAND flash memory of the wireless switch) are bypassed in response to the boot instructions; and the intermediate processing element accesses and reads the boot code from the nonvolatile memory card in response to the boot instructions.

Eventually, boot process 500 can complete the boot procedure (task 516) using the boot code read from the nonvolatile memory card. In this regard, the intermediate processing element provides the mechanism that allows the wireless switch to boot in the alternate mode. Notably, the main processing element need not be aware that it is booting up from a source other than its internal flash memory components. The intermediate processing element emulates the normal boot conditions for the main processing element—the intermediate processing element functions as a proxy component that performs translations on the format, structure, and/or arrangement of data read from the nonvolatile memory card. This feature is desirable because during the boot routine the main processing element may be unable to communicate directly with the nonvolatile memory card, and the main processing element may initially be unable to read the memory sectors of the nonvolatile memory card (until some time after the first few hundred instructions).

In practice, the intermediate processing element need not influence the operation of the wireless switch after booting. Once boot process 500 has completed and the wireless switch is operating, the main processing element should be able to communicate with the memory card interface and the nonvolatile memory card without the assistance of the intermediate processing element. Indeed, the boot code stored in the nonvolatile memory card may inform the main processing element that there is additional code stored in the nonvolatile memory card, where such additional code may be the drivers that allow the main processing element to interact directly with the nonvolatile memory card. After booting, therefore, the intermediate processing element may simply function as a pass-through element that does not alter or modify data.

While at least one example embodiment has been presented in the foregoing detailed description, it should be appreciated that a vast number of variations exist. It should also be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention, where the scope of the invention is defined by the claims, which includes known equivalents and foreseeable equivalents at the time of filing this patent application.

What is claimed is:

1. A wireless switch subsystem for a wireless local area network (WLAN), the wireless switch subsystem comprising:
a wireless switch comprising an integrated memory card interface; and
a nonvolatile memory card that is compliant with the memory card interface, the nonvolatile memory card including boot code for the wireless switch stored therein.

2. A wireless switch subsystem according to claim 1, the wireless switch further comprising a network communication module configured to support data communication with a network component to which the wireless switch is connected, the memory card interface being coupled to the network communication module.

3. A wireless switch subsystem according to claim 1, wherein:
the memory card interface is CompactFlash compliant; and
the nonvolatile memory card is a CompactFlash card.

4. A wireless switch subsystem according to claim 1, the wireless switch comprising processing logic configured to manage storage of client device data in the nonvolatile memory card.

5. A wireless switch subsystem according to claim 1, the wireless switch comprising processing logic configured to manage storage of log data for the wireless switch in the nonvolatile memory card.

6. A wireless switch subsystem according to claim 1, the wireless switch comprising processing logic configured to:
access supplemental code stored in the nonvolatile memory card; and
update operating code of the wireless switch in accordance with the supplemental code.

7. A wireless switch subsystem according to claim 1, the wireless switch comprising processing logic configured to:
access the boot code stored in the nonvolatile memory card; and
initiate a boot procedure for the wireless switch in response to the boot code.

8. A method of operating a wireless switch for a wireless local area network (WLAN), the wireless switch having an integrated memory card interface, the method comprising:
coupling a nonvolatile memory card to the memory card interface, the nonvolatile memory card including boot code for the wireless switch stored therein;
entering a recovery mode for the wireless switch; and
booting the wireless switch from the nonvolatile memory card in response to entering the recovery mode.

9. A method according to claim 8, wherein booting the wireless switch comprises:
reading the boot code from the nonvolatile memory card; and
presenting the boot code to a main processing element of the wireless switch.

10. A method according to claim 9, further comprising holding the main processing element in reset in response to entering the recovery mode.

11. A method according to claim 10, further comprising releasing the main processing element from reset prior to presenting the boot code to the main processing element.

12. A method according to claim 8, wherein:
the wireless switch comprises a boot memory element including primary boot code for the wireless switch stored therein;
the wireless switch comprises a main processing element coupled to the boot memory element, the main processing element being configured to access the primary boot code for booting the wireless switch in a normal operating mode; and
booting the wireless switch comprises:
receiving boot instructions from the main processing element;
bypassing the boot memory element in response to the boot instructions; and
accessing the boot code from the nonvolatile memory card in response to the boot instructions.

13. A method according to claim 8, wherein entering the recovery mode is responsive to manipulation of a selection feature on the wireless switch.

14. A wireless switch for a wireless local area network (WLAN), the wireless switch comprising:
a main processing element;
an integrated memory card interface configured for interconnection with a compatible nonvolatile memory card having boot code for the wireless switch stored therein; and
an intermediate processing element coupled to the main processing element and to the memory card interface, the intermediate processing element being configured to read boot code for the wireless switch stored in the nonvolatile memory card, and to present the boot code to the main processing element.

15. A wireless switch according to claim 14, the main processing element being configured to manage storage of client device data in the nonvolatile memory card.

16. A wireless switch according to claim 14, the main processing logic being configured to manage storage of log data for the wireless switch in the nonvolatile memory card.

17. A wireless switch according to claim 14, the intermediate processing element being configured to access supplemental code stored in the nonvolatile memory card, the supplemental code representing update software for the wireless switch.

18. A wireless switch according to claim 14, the main processing element being configured to initiate a boot procedure for the wireless switch in response to the boot code.

19. A wireless switch according to claim 14, wherein:
the memory card interface is CompactFlash compliant; and
the nonvolatile memory card is a CompactFlash card.
